(19) United States
(12) Patent Application Publication
(10) Pub. No.: US 2013/0219436 A1
(43) Pub. Date: Aug. 22, 2013

(54) EQUIPMENT FOR RECEPTION SYSTEMS, PARTICULARLY A SINGLE CABLE SYSTEM FOR MULTIPLE USERS

(71) Applicant: Karl Mantinger, Auer (IT)

(72) Inventor: Karl Mantinger, Auer (IT)

(21) Appl. No.: 13/818,742

(22) PCT Filed: Aug. 24, 2011
(86) PCT No.: PCT/EP2011/064548

§ 371 Date: May 3, 2013

(30) Foreign Application Priority Data
Aug. 25, 2010 (IT) BZ2010A00031

(51) Int. Cl. H04N 21/61

(52) U.S. Cl. CPC H04N 21/6143
USPC 725/68

(57) ABSTRACT

An equipment (4) for video TV/radio signal and data reception systems adapted to be connected to at least one aerial (2), which transmits a signal to it, and to be connected by means of a single cable (12) to a user (16, 16a, 16b, 16c, 16d, 16e, 16n) is described.

According to the invention, said equipment (4) comprises a satellite/terrestrial receiver (5) for each user (16, 16a, 16b, 16c, 16d, 16e, 16n), said receiver (5) sending out a channel (7a, 7b, 7c, 7d, 7e, 7n) associated exclusively with a frequency band (9a, 9b, 9c, 9d, 9e, 9n) and said frequency band (9a, 9b, 9c, 9d, 9e, 9n) being associated exclusively with a user (16, 16a, 16b, 16c, 16d, 16e) and said equipment (4) comprising means adapted (17) to remotely change said outgoing channel (7a, 7b, 7c, 7d, 7e, 7n) from the satellite/terrestrial receiver (5).

The present invention relates to an equipment for reception systems, particularly a single cable aerial system for multiple users.

Reception systems are known from the prior art as is disclosed in EP 1 968 219 A1. Here satellite programs are transferred by means of a frequency converter (modulator) to the head-end in an associated frequency band (FB1, FB2, FB3, etc.) and sequentially entered in a single cable connection. The program change is performed by the user by means of an adjustable frequency tuner on the respective frequency band (FB1, FB2, FB3, etc.).

The consequence of this application is that there is not enough space in the traditional single cable for the numerous programs received (>2000) due to the system or respectively the frequencies which can only be entered in a reduced form.

The object of the present invention is to create an equipment for single cable reception systems adapted to receive all channels from multiple satellite, terrestrial aerials and/or video data channels without restrictions.

This object is achieved by an equipment for reception systems according to the characterising part of claim 1.

An equipment for TV/radio signal or other video signal and data reception systems adapted to be connected to at least one aerial, which transmits a signal to it, and to be connected by means of a single cable to a user, comprises for each user a satellite/terrestrial receiver (combo -receiver), said receiver sending out a channel associated exclusively with a frequency band and said frequency band being associated exclusively with a user and said equipment comprising means adapted to remotely change said outgoing channel from the satellite/terrestrial receiver (combo-receiver).

The single cable system according to the invention can be especially employed in the field of common single cable aerial reception systems for apartment blocks or hotels.

This is advantageous in that with the existing single cables there is no need to make any changes to the cable structure in order to receive all analog/digital TV programs and data, and video broadcasting without restrictions, which reduces the installation costs to a minimum while guaranteeing at the same time a flexible system for future changes.

The head-end is conformed so that all satellite, terrestrial programs and video/audio signals and data, as well as the radio ones can be selected and entered without restrictions into an existing single cable network through a frequency channel permanently associated with the user. The only restriction relates to the number of users which is limited to the frequency bands available or the single cable channels available.

The single cable system is designed so that the change of incoming satellite, terrestrial programs and video/audio signals and data or radio is performed on the head-end by means of a satellite/terrestrial receiver (combo-receiver), on which a remote control coordinated with the association with the addresses works. It is used to select the program only by means of a demodulated modulator at a fixed transmission frequency digitally/analogically and in the single cable connection inserted for the corresponding user device.

Single combo-receivers on the head-end are supplied to a multiple selector (multiswitch) of the known type and are designed to select the satellite, the H/V position and the channel among all satellite receivable programs, as well as all terrestrial ones, and video/audio signals and data. Hence, the program change preferably occurs through a coded radio transmission remote control, which can be exclusively associated with a device and the corresponding satellite/terrestrial receiver (combo-receiver) on the head-end. In a further embodiment, the command to change the signal can occur through the single cable by means of a signal emitted by a switching apparatus interposed between the user device and the single cable which acts on the head-set.

Each user can send the signal through the remote control to the head-set where the associated satellite/terrestrial receiver (combo-receiver) is arranged by means of a signal directly sent to said receiver or by means of the single cable or other known systems, by means of which it is possible to select the desired program.

As soon as the program is selected and the signal is sent to the head-end, the selected program is turned by means of a frequency modulator into an associated frequency band and entered into the single cable by means of a mixer. The frequency tuner of the associated user, which is strictly set on the same frequency band, should not be changed.

For example, for 10 users only 10 frequency bands (channels) of analog/digital type are necessary in the single cable, in order to receive all the programs with traditional digital/analog devices.

On the head-end side receiving the program and to which a program change is commanded, either a command receiver for the wireless signal of a user wanting to change the program or a command receiver for the signal by means of the single cable or another connection is required, such as for example a land line connection and a receiver for incoming programs to the head-end receiving satellite, terrestrial programs and video/audio signals and data, or radio. Hence, a satellite/terrestrial receiver (combo-receiver) interposed between the single cable and the user device or within the user device would no longer be necessary, and neither would an adjustable tuner built into the user device.

Through arranging simple audio/video demodulators, with the purpose of adapting the associated signal in the plug to the respective reception device, the use of simple monitors up to high-definition equipment is also provided.

The digital input of a DVB (“Digital Video Broadcasting”) signal into the conventional VHF/UHF field allows the user limit to be increased, which has thousands of channels available to more than 200 users.

If a user requests a further television/radio, video and data connection to the head-end, a new satellite/terrestrial receiver (combo-receiver) can be simply added and a new frequency band can be associated thereto. This then enables reception of the user signal on the same plug on which the first signal was received. This allows the viewing of one channel, for example, on the monitor and recording of another channel at the same time on a recording device, for example a hard disk. The channel change is performed on the head-end. The change can be performed by means of a wireless signal directly on the head-end through a remote control or by means of a return signal through the single cable or a known connection, such as for example a conventional land line.

In the drawing, an equipment according to the invention and a system comprising said equipment are shown, the drawings showing:

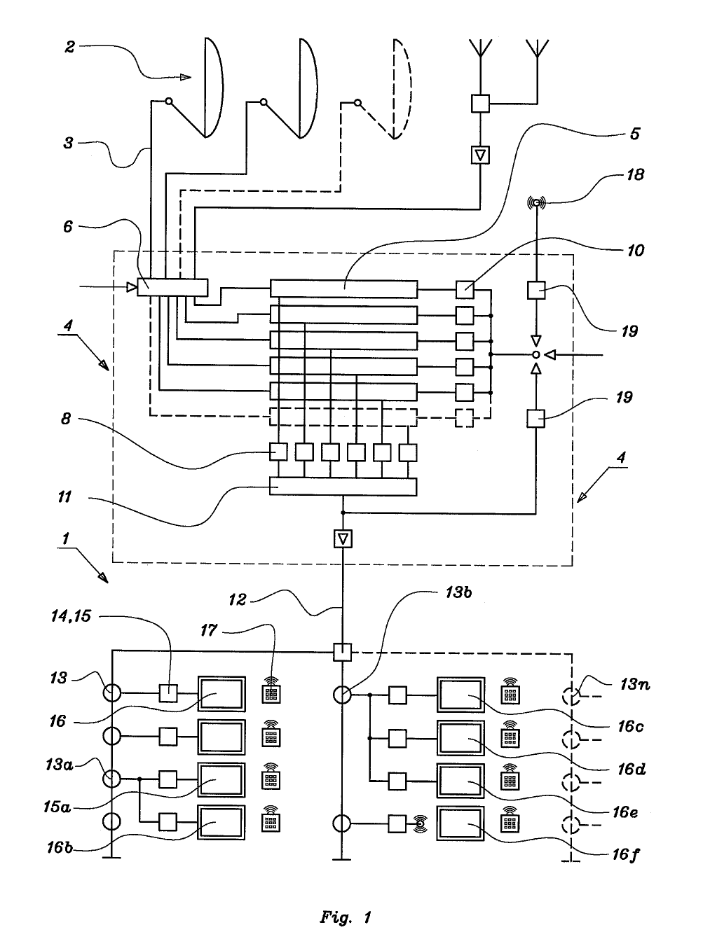

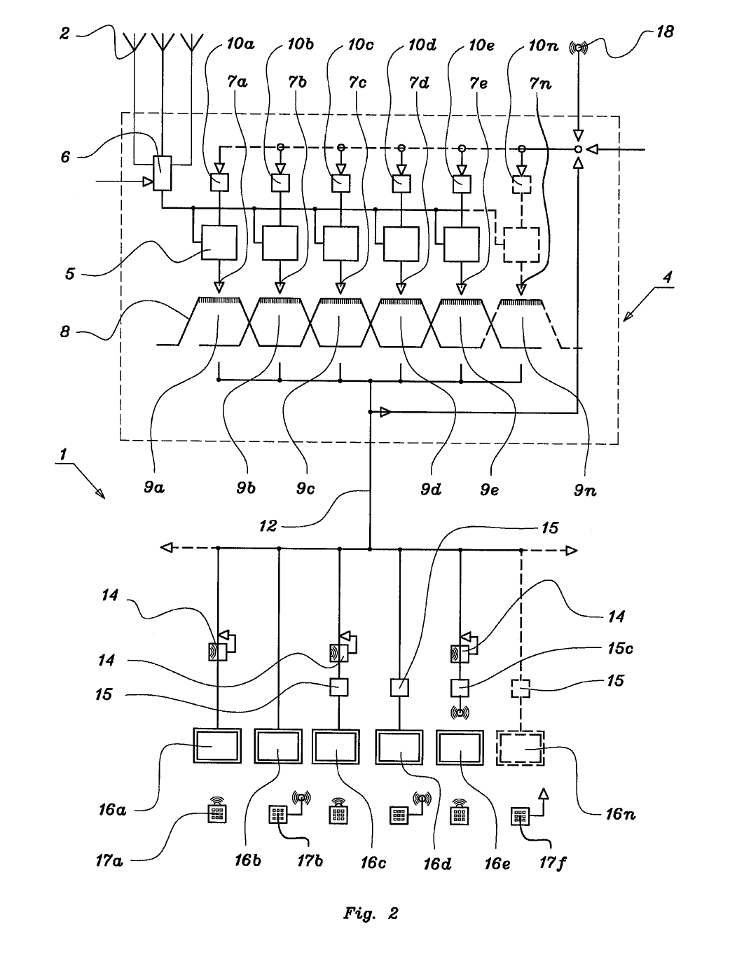

FIG. 1 a schematic system in detail according to the invention, and FIG. 2 a block schematic system according to the invention with the association of an outgoing signal from the equipment according to the invention at a frequency band and the command sending mode for changing the programs.

In FIG. 1 a schematic system 1 for the reception and use of a TV/Radio and video/data signal is shown.

This system comprises at least one aerial 2, connected through a connection cable 3 to a head-end 4. This equipment for system 4 for the reception of TV/radio and video signals and data is connected by means of a single cable 12 to a user 16. The head-end 4 comprises for each user 16 a satellite/terrestrial receiver (combo-receiver) 5 to which a multiple selector (multiswitch) 6 is connected to manage the selection of the aerials 2 and the corresponding polarisation of the incoming signal. Said satellite/terrestrial receiver (combo-receiver) 5 sends out a channel 7a, 7b . . . , exclusively associated with a frequency band 9a, 9b . . . This frequency band 9a, 9b, . . . is associated by means of frequency modulators 8 exclusively with a user 16a, 16b . . . and said equipment 4 comprises means 10a, 10b, 10c . . . adapted to remotely change said outgoing channel from the satellite/terrestrial receiver (combo-receiver) 4.

Multiple users 16a, 16b . . . , such as for example a TV and a recorder in series using two different frequency bands 9 on the single cable 12, can be connected to a plug 13a, 13b . . . of the single cable 12.

To change the outgoing channel from the satellite/terrestrial receiver (combo-receiver) 5 a signal is sent to the latter for example by means of a remote control 17 or by means of a signal passing through a switching device 14 by the single cable 12 or by means of a conventional cable connection, such as for example by means of a land line (BUS) , by means of the electrical mains, by means of a traditional land line, or by means of a wireless signal 18. Each signal is sent to the head-end 4 and is exclusively associated with a user 16.

This system according to the invention allows for the easy and centralised control and programming which can be managed, for example, by a PC at a hotel reception.

This system comprises an equipment according to the invention comprising at least one aerial 18 connected to said equipment adapted to transmit a signal, a single cable 12 adapted to connect said equipment to at least one user and a remote control 17 adapted to change the outgoing channel of said equipment and a plug 13 connected to said single cable 12.

In a preferred embodiment a tuning and transforming device 15 is provided adapted to tune and transform the signal associated with said single cable channel 12 at the plug 13 exit into a signal adapted to a user and it is interposed between the plug 13 and the user 16. This connection between the tuning and transforming device 15 and the user 16 can be performed wirelessly.

In another embodiment, the user 16b all elements as the switching device 14 and the tuning and transforming device 15 are integrated.

In addition, the user 16 also act as a display for the settings and control of the head-end station or other connected systems. It could be, for example, connect the air conditioning or the shutter control and the settings are displayed and can be controlled via the remote control or on the other controls.

List of reference numerals
1 Schematic system
2 Aerial
3 Connection cable
4 Equipment
5 Satellite/terrestrial receiver (combo-receiver)
6 Multiple selector (multiswitch)
7a, 7b, 7c, 7d, 7e, 7n Outgoing channel
8 Frequency modulator
9a, 9b, 9c, 9d, 9e, 9n Frequency bands
10, 10a, 10b, 10c, 10d, 10e, 10n, Means for remote controls
11 Signal mixer (combiner)
12 Single cable
13, 13a, 13b Plug
14 Switching device
15 Signal tuning and transforming device
16, 16a, 16b, 16c, 16d, 16e, 16n Users
17, 17a, 17b, 17f Remote control
18 Reception aerial

1. Equipment for TV/radio video signal and data reception systems adapted to be connected to at least one aerial, which transmits a signal to it, and to be connected by means of a single cable to a user, characterised in that said equipment comprises a satellite/terrestrial receiver for each user, said receiver sending out a channel associated exclusively with a frequency band and said frequency band being associated exclusively with a user and said equipment comprising means adapted to remotely change said outgoing channel from the satellite/terrestrial receiver.

2. The equipment according to claim 1, characterised in that multiple users can be connected by means of the single cable and a plug in series.

3. The equipment according to claim 1, characterised in that the means for remotely changing said outgoing channel are wireless.

4. The equipment according to claim 1, characterised in that the means for remotely changing said outgoing channel are operated by means of a switching device through the single cable.

5. The equipment according to claim 1, characterised in that the means for remotely changing said outgoing channel are operated by means of a known connection such as, for example, by means of a land line connection (BUS), through the electrical mains or through a telephone line.

6. A system comprising equipment according to claim 1, characterised in that it comprises at least one aerial connected to said equipment adapted to transmit a signal, a single cable adapted to connect said equipment with at least one user and remote control adapted to change the outgoing channel on said equipment and a plug connected to said single cable.

7. The system according to claim 6, characterised in that a device for tuning and transforming signals adapted to transform the signal associated with said channel of the single cable to the plug output is positioned between the plug and the user.

8. The system according to claim 6, characterised in that the tuning device connected to the plug transmits the outgoing signal wirelessly to the user.

9. The system according to claim 1, characterized in that the switching device and the signal tuning and transforming device are integrated in the user.

10. The system according to claim 1, characterized in that the user represents the controls and/or the settings of the connected systems visually.

11. The system according to claim 10, characterized in that the control of the illustrated systems is controlled via the control of the system.
